(19) United States
(12) Patent Application Publication
(10) Pub. No.: US 2025/0012338 A1
(43) Pub. Date: Jan. 9, 2025

(54) MOTION STATE DISPLAY DEVICE AND MOTION STATE DISPLAY METHOD

(71) Applicant: ATSUMITEC CO., LTD., Hamamatsu-shi (JP)

(72) Inventors: Junichi Ishimoto, Hamamatsu-shi (JP); Sungmin LEE, Hamamatsu-shi (JP); Kaito KASAHARA, Hamamatsu-shi (JP)

(21) Appl. No.: 18/762,145

(22) Filed: Jul. 2, 2024

(30) Foreign Application Priority Data
Jul. 7, 2023 (JP) 2023-111988
Mar. 25, 2024 (JP) 2024-048612

(51) Int. Cl. F16F 9/32; F16D 57/00; F16F 9/53

(52) U.S. Cl. CPC F16F 9/3264; F16D 57/002; F16F 9/535; F16F 2222/06; F16F 2224/045

(57) ABSTRACT

A motion state display device includes a cable that is paid out in response to movement of a user, a reel on which the cable is wound, a rotary encoder to detect a rotation state of the reel, a magneto-rheological fluid brake to apply a braking force to the reel, a controller configured or programmed to control the braking force according to a stroke amount of the cable calculated based on an output value of the rotary encoder, to change a load for the movement, and a display to display an actual measured waveform of a speed at which the cable is paid out.

### CROSS REFERENCE TO RELATED APPLICATIONS

This application claims the benefit of priority to Japanese Patent Application No. 2023-111988 filed on Jul. 7, 2023 and Japanese Patent Application No. 2024-048612 filed on Mar. 25, 2024. The entire contents of these applications are hereby incorporated herein by reference.

### BACKGROUND OF THE INVENTION

### 1. Field of the Invention

The present invention relates to motion state display devices and motion state display methods.

### 2. Description of the Related Art

For muscle strengthening or rehabilitation, a training apparatus that utilizes the weight of a weight is often used. Generally, such a training apparatus for weight training is configured for a certain movement for applying a concentrated load to a target for muscle training, such as a certain muscle or a body part, and is designed to allow for load adjustment by adjusting the weight of the weight.

However, a training apparatus that allows for adjusting a magnitude of the load without using a weight is also known. For example, muscle training apparatuses disclosed in Japanese Unexamined Patent Application Publication No. 2002-126122 and Japanese Patent No. 4956808 include a handle-shaped operation unit to be rotated by a trainee, and the muscle training apparatuses apply electromagnetic rotational resistance that resists the operation. More specifically, in these conventional technologies, a rotating body that rotates in response to rotation operation of the handle by a trainee is placed in an electro-rheological or magneto-rheological fluid, and the load experienced by the user is adjusted by controlling a magnitude of electricity or magnetism applied to the viscous fluid to control viscous resistance against the rotation.

Furthermore, U.S. Pat. No. 4,956,808 describes an example method of muscle strength characteristic evaluation in which muscle strength characteristics are evaluated based on an angle, angular velocity, torque of rotation operation of the handle on the training apparatus, and power data calculated based on the angle, angular velocity, and torque, and are output to a display or the like.

### SUMMARY OF THE INVENTION

However, in the muscle strength characteristic evaluation method using the above-described training apparatuses, a load is applied to a simple movement that uses only a specific muscle or body part that is training target. Such a load may not be appropriate for a practical sport movement, and thus, the above-described training apparatuses may be unsuitable for motion state evaluation suitable for improving sport performance. In particular, in the muscle strength characteristic evaluation method according to the above-mentioned conventional technology, a movement form is restricted by the structure of the apparatus, and thus it is not possible to achieve a training state that involves coordination of the muscles of the entire body. For reasons including this, the conventional technologies are unstable for motion state evaluation for improving performance.

Example embodiments of the present invention provide motion state display devices and motion state display methods that each allow for performance evaluation in line with a practical sport movement.

A first example embodiment of the present invention is a motion state display device, including a cable that is paid out in response to movement of a user, a measurer to measure a stroke amount of the cable, a magneto-rheological fluid brake to apply a braking force to the cable, a controller configured or programmed to control the braking force according to the stroke amount of the cable calculated based on an output value of the measurer, to change a load for the movement, and a display operable to display a paying-out rate at which the cable is paid out.

The motion state display device according to the first example embodiment of the present invention can calculate a stroke amount of the cable with respect to movement of a user and change the braking force against paying out of the cable, according to the stroke amount, to change the magnitude of the load during the movement. Here, the user's movement in three-dimensional space is not restricted by the structure of the device, and, for example, the user is subjected to a load during a realistic movement that involves coordination of the muscles of the entire body. Thus, the motion state display device allows for visualization of paying-out rate of the cable during a realistic movement, and thus performance evaluation in line with a practical sport movement.

A second example embodiment of the present invention is a motion state display device, including, a cable that is paid out in response to movement of a user, a measurer to measure a stroke amount of the cable, a magneto-rheological fluid brake to apply a braking force to the cable, a controller configured or programmed to control the braking force according to the stroke amount of the cable calculated based on an output value of the measurer, to change a load for the movement, and a display operable to display speed information of the cable.

The motion state display device according to the second example embodiment of the present invention can calculate a stroke amount of the cable with respect to movement of a user and change the braking force against paying out of the cable, according to the stroke amount, to change the magnitude of the load during the movement. Here, the user's movement in three-dimensional space is not restricted by the structure of the device, and, for example, the user is subjected to a load during a realistic movement that involves coordination of the muscles of the entire body. Thus, the motion state display device allows for visualization of speed information of the cable during a realistic movement, and thus performance evaluation in line with a practical sport movement.

A third example embodiment of the present invention is a motion state display device, including, a cable that is paid out in response to movement of a user, a measurer to measure a stroke amount of the cable, a magneto-rheological fluid brake to apply a braking force to the cable, a controller configured or programmed to control the braking force according to the stroke amount of the cable calculated based on an output value of the measurer, to change a load for the movement, and a display operable to display an actual measured waveform of a speed at which the cable is paid out.

The motion state display device according to the third example embodiment of the present invention can calculate a stroke amount of the cable with respect to movement of a user and change the braking force against paying out of the cable, according to the stroke amount, to change the magnitude of the load during the movement. Here, the user's movement in three-dimensional space is not restricted by the structure of the device, and, for example, the user is subjected to a load during a realistic movement that involves coordination of the muscles of the entire body. Thus, the motion state display device allows for visualization of speed changes during a realistic movement, and thus performance evaluation in line with a practical sport movement.

A fourth example embodiment of the present invention is the motion state display device of the third example embodiment of the present invention in which the display is operable to display a targeted waveform of the speed.

The motion state display device according to the fourth example embodiment of the present invention allows for a user to know and compare an actual measured waveform and a targeted waveform for each timing, and thus to perform motion state evaluation suitable for improving performance.

A fifth example embodiment of the present invention is the motion state display device of the third or fourth example embodiment of the present invention in which the display is operable to display a waveform of the load according to the stroke amount.

The motion state display device according to the fifth example embodiment of the present invention in which the actual measured waveform of speed and the waveform of the load are simultaneously displayed allows for a user to visually recognize whether the movement speed drops excessively at the timing of a peak load, for example, and to evaluate whether the movement is appropriate for a desired training.

A sixth example embodiment of the present invention is a motion state display method including measuring a stroke amount of a cable that is paid out in response to movement of a user, applying to the cable a braking force according to the stroke amount to change a load for the movement, and displaying a paying-out rate at which the cable is paid out.

The motion state display method according to the sixth example embodiment of the present invention can calculate a stroke amount of the cable with respect to movement of a user and change the braking force against paying out of the cable, according to the stroke amount, to change the magnitude of the load during the movement. Here, the user's movement in three-dimensional space is not restricted, and, for example, the user is subjected to a load during a realistic movement that involves coordination of the muscles of the entire body. Thus, the motion state display method allows for visualization of paying-out rate of the cable during a realistic movement, and thus performance evaluation in line with a practical sport movement.

A seventh example embodiment of the present invention is a motion state display method including measuring a stroke amount of a cable that is paid out in response to movement of a user, applying to the cable a braking force according to the stroke amount to change a load for the movement, and displaying speed information of the cable.

The motion state display method according to the seventh example embodiment of the present invention can calculate a stroke amount of the cable with respect to movement of a user and change the braking force against paying out of the cable, according to the stroke amount, to change the magnitude of the load during the movement. Here, the user's movement in three-dimensional space is not restricted, and, for example, the user is subjected to a load during a realistic movement that involves coordination of the muscles of the entire body. Thus, the motion state display method allows for visualization of speed information of the cable during a realistic movement, and thus performance evaluation in line with a practical sport movement.

An eighth example embodiment of the present invention is a motion state display method including measuring a stroke amount of a cable that is paid out in response to movement of a user, applying to the cable a braking force according to the stroke amount to change a load for the movement, and displaying an actual measured waveform of a speed at which the cable is paid out.

The motion state display method according to the eighth example embodiment of the present invention can calculate a stroke amount of the cable with respect to movement of a user and change the braking force against paying out of the cable, according to the stroke amount, to change the magnitude of the load during the movement. Here, the user's movement in three-dimensional space is not restricted, and, for example, the user is subjected to a load during a realistic movement that involves coordination of the muscles of the entire body. Thus, the motion state display method allows for visualization of speed changes during a realistic movement, and thus performance evaluation in line with a practical sport movement.

A ninth example embodiment of the present invention is the motion state display method of the eighth example embodiment of the present invention in which the displaying includes displaying a targeted waveform of the speed.

The motion state display method according to the ninth example embodiment of the present invention allows for a user to know and compare an actual measured waveform and a targeted waveform for each timing, and thus to perform motion state evaluation suitable for improving performance.

A tenth example embodiment of the present invention is the motion state display method of the eighth or ninth example embodiment of the present invention in which the displaying includes displaying a waveform of the load according to the stroke amount.

The motion state display method according to the tenth example embodiment of the present invention in which the actual measured waveform of speed and the waveform of the load are simultaneously displayed allows for a user to visually recognize whether the movement speed drops excessively at the timing of a peak load, for example, and to evaluate whether the movement is appropriate for a desired training.

Example embodiments of the present invention provide motion state display devices and motion state display methods each allowing for performance evaluation in line with a practical sport movement.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a conceptual diagram illustrating an example of use of a motion state display device according to a first example embodiment of the present invention.

FIG. 2 is a schematic diagram illustrating an internal structure of the motion state display device.

FIG. 3 is a waveform diagram showing movement speed and a load curve corresponding to a series of movements.

FIG. 4 is a perspective view illustrating appearance of a motion state display device according to a second example embodiment of the present invention.

FIG. 5 is a conceptual diagram illustrating an example of use of a motion state display system according to a third example embodiment of the present invention.

### DETAILED DESCRIPTION OF THE EXAMPLE EMBODIMENTS

Hereinafter, example embodiments of the present invention will be described in detail with reference to drawings. Note that the present invention is not limited to the contents described below, and can be modified and implemented as desired without departing from the spirit of the present invention. All of the drawings used to explain the example embodiments illustrate components schematically, and include parts that are emphasized or scaled, or omission to facilitate understanding, and thus may not accurately represent the scale or shape of the components.

### First Example Embodiment

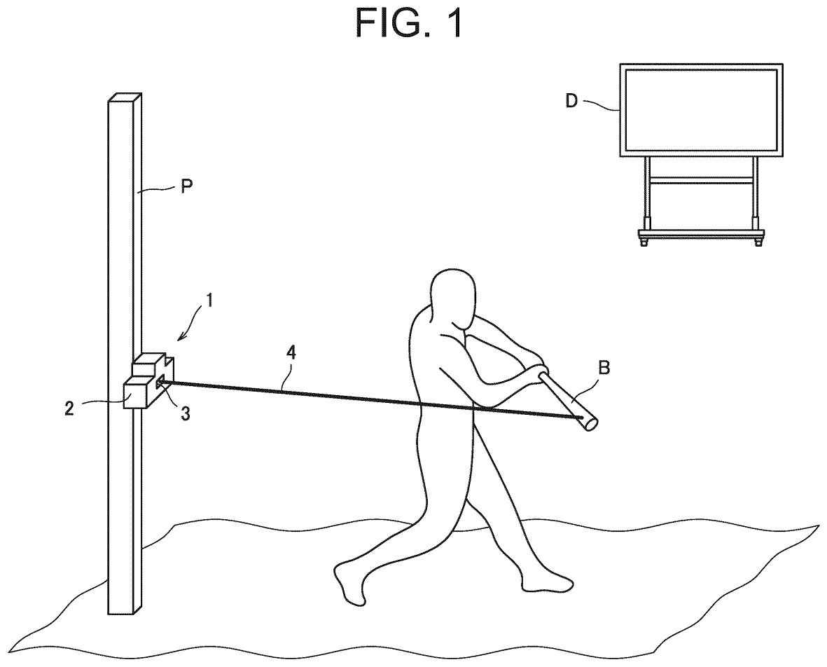

FIG. 1 is a conceptual diagram illustrating an example of use of a motion state display device 1 according to a first example embodiment. The motion state display device 1 is a device that can generate practical loads in line with movements in various sports to allow for performance evaluation. In the present example embodiment, the motion state display device 1 will be described using an example of use in baseball batting practice.

The motion state display device 1 has a configuration in which a cable 4 is paid out from an opening unit 3 provided, in appearance, on a front side of a housing 2, and an end of the cable 4 is connected to or to the vicinity of the center of a bat B. As will be described in detail later, the motion state display device 1 displays, on a display D, a waveform of swing speed when a training load is changed during a swing of the bat B by applying a resistive force against a force pulling the cable 4 according to a stroke amount of the cable 4 that is being paid out in response to batting movements of a user. Alternatively, the cable 4 may be connected to a wrist of the user.

In the present example embodiment, the motion state display device 1 is fixed to a predetermined position on a support P, but the fixation position may be changed depending on the movement or user, and the motion state display device 1 may be fixed to a wall, ceiling, or floor depending on the usage form.

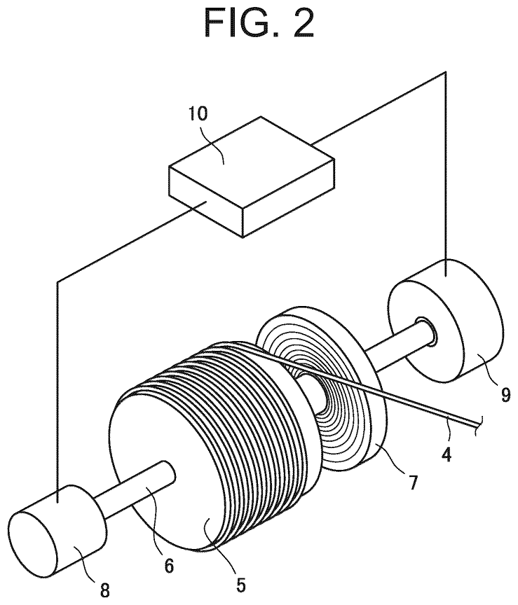

FIG. 2 is a schematic diagram illustrating the internal structure of the motion state display device 1. Generally, a reel 5, a rotating shaft 6, a spiral spring 7, a rotary encoder 8, a magneto-rheological fluid brake 9, and a controller 10 are contained inside the housing 2.

The reel 5 is a cylindrical structure on which the cable 4 is wound. The rotating shaft 6 is fixed at a shaft center of the reel 5. The spiral spring 7 includes a strip of metal wound around the rotating shaft 6, and includes an inner end fixed to the rotating shaft 6 and an outer end fixed, for example, to an inner wall surface of the housing 2. As a result, the spiral spring 7 provides an urging force for winding, on the reel 5, the cable 4 that has been paid out.

The rotary encoder 8 is fixed to the housing 2 and detects, via the rotating shaft 6, a rotation state of the reel 5. Here, the rotation state is, for example, time-series information of the rotation angle, and is used to calculate the stroke amount and a paying-out rate when the cable 4 is paid out. Thus, in the present example embodiment, the reel 5 on which the cable 4 is wound and the rotary encoder 8 that detects the rotation state of the reel 5 define a “measurer” to measure the stroke amount of the cable 4.

The magneto-rheological fluid brake 9 is a known magneto-rheological fluid (MRF) device that controls the magnitude of applied magnetism to exert viscous resistance against an input rotational force. In the present example embodiment, the magneto-rheological fluid brake 9 applies a braking force against the rotation of the reel 5 via the rotating shaft 6, thereby applying a load to the paying out of the cable 4. If there is no force to pay out the cable 4, the braking force is released and the urging force by the spiral spring 7 causes the cable 4 to be wound onto the reel 5.

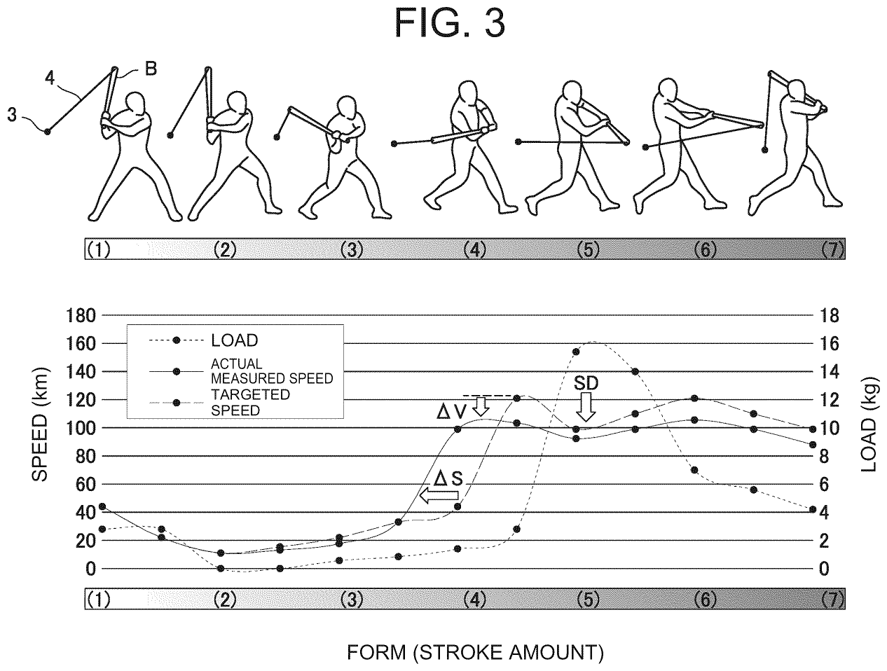

The controller 10 includes, for example, a known microcontroller control circuit, and is configured or programmed to calculate, based on an output value of the rotary encoder 8, a paid-out length of the cable 4, that is, the stroke amount. The controller 10 is configured or programmed to store a load curve (see FIG. 3) representing a relationship between the stroke amount of the cable 4 and the braking force by the magneto-rheological fluid brake 9. The controller 10 is configured or programmed to generate a braking force in the magneto-rheological fluid brake 9, based on a load curve described below, according to the stroke amount that changes during the movement.

FIG. 3 is a waveform diagram showing movement speed and a load curve corresponding to a series of movements. More specifically, the upper diagram of FIG. 3 illustrates a changes in form during a batting movements used as an example in the present example embodiment, and illustrates changes in the stroke amount of the cable 4 corresponding to the changes in form.

At this time, inside the motion state display device 1, the cable 4 wound around the reel 5 is paid out in response to movement of a user, and the rotation state of the reel 5 is detected by the rotary encoder 8. The controller 10 is configured or programmed to measure the stroke amount of the cable 4 based on the rotation state of the reel 5 (a stroke amount measurement step). Furthermore, the controller 10 is configured or programmed to control the magneto-rheological fluid brake 9 to apply, to the reel 5, a braking force according to the calculated stroke amount, to change the load for the movement (a load change step).

Then, the controller 10 is configured or programmed to calculate, correspondingly to the stroke amount, the speed at which the cable 4 is paid out based on the output value of the rotary encoder 8, and transmit the calculated speed to the display D via a wired or wireless communication module (not illustrated). As a result, the display D displays the actual measured waveform of the speed at which the cable 4 is paid out, as illustrated by the solid line in the lower diagram of FIG. 3 (a display step).

A motion state display method including the steps described above allows for a user of the motion state display device 1 to check his/her own movement performance on the display D. More specifically, the display D visualizes, as a waveform, changes of the speed of the cable 4 with respect to the stroke amount [mm] corresponding to the define at each moment, as illustrated in the lower diagram of FIG. 3. Thus, the user can know the swing speed at each timing during the batting movements.

Furthermore, the display D can superimpose a targeted waveform of speed on the display of the actual measured waveform of the swing speed. This allows the user to compare the actual measured waveform with the targeted waveform, and perform motion state evaluation suitable for improving performance. For example, if excessive force is applied during the swing movement, it can be observed that the timing of rise in the actual measured speed is earlier than that in the targeted speed (ΔS), and thus the force is dispersed and the peak speed does not increase sufficiently (ΔV).

Furthermore, the display D can superimpose, on the display of the waveform of the swing speed, a load curve representing changes in the load W [kg] of the braking force generated by the magneto-rheological fluid brake 9. The load curve is a waveform of the load applied to the user during movement according to the stroke amount, and is set in advance according to the type and characteristics of the movement. In the case of a batting movements as described in the present example embodiment, the set waveform has a low load at the start of the swing of the bat B, and reaches the maximum load, Wmax at the timing of impact indicated by (5) in FIG. 3. More specifically, in this example, the set waveform reaches the maximum load, Wmax of 16 [kg] at the timing when the stroke amount is 150 [mm], for example.

Displaying the load curve in a superimposed manner allows for the user to visually recognize, for example, whether the swing speed drops excessively at the timing of the peak load (SD), and evaluate whether the batting can overcome the shock at the moment of impact.

The load curve can be set based on prior measurements based on theoretical values for each movement. Adjustment of characteristics such as the magnitude of the maximum load, Wmax at an impact point and a peak position depending on parameters such as expected ball speed and type of ball, can be implemented by modifying the waveform of the load curve.

Here, the above load curve may be stored in the controller as a plurality of variation waveforms having different characteristics, or may be appropriately received from an external source as load curve data. The user can select and adjust the load curve such that the magnitude of the load is changed according to progression of movement of the user, and thus can perform evaluation of motion state in a practical movement suited to a purpose.

As described above, the motion state display device 1 of the present example embodiment can change the magnitude of the load based on the stroke amount of the cable 4, and thus can reproduce a realistic load without restricting a movement form. Therefore, the motion state display device 1 allows for performance evaluation in line with a practical sport movement.

### Second Example Embodiment

Next, a second example embodiment of the present invention will be described. A motion state display device 11 according to the second example embodiment differs from the motion state display device 1 of the first example embodiment in a portion from which the cable 4 is paid out. Hereinafter, only the portion that differs from that of the first example embodiment will be described, and the components common to the first and second example embodiments are denoted by the same reference signs and detailed description thereof will be omitted.

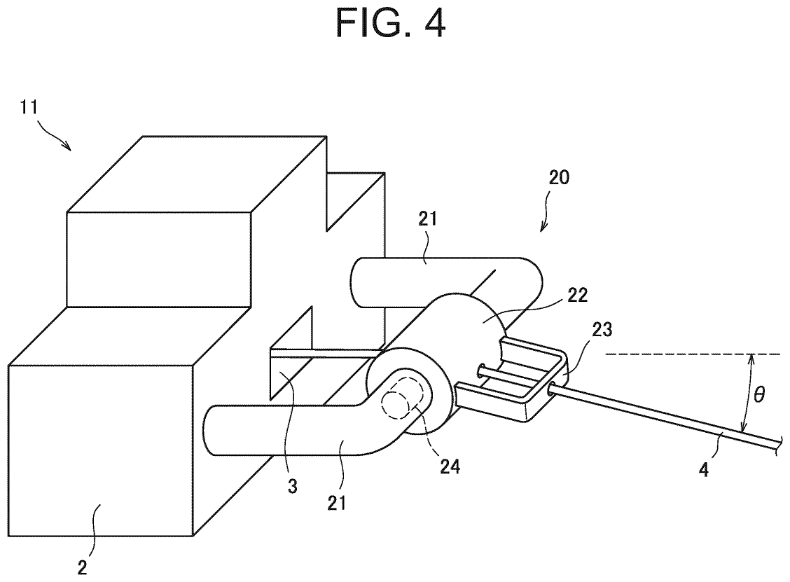

FIG. 4 is a perspective view illustrating appearance of the motion state display device 11 according to the second example embodiment. The housing 2 and the internal structure of the motion state display device 11 are substantially the same as those of the motion state display device 1 of the first example embodiment. The motion state display device 11 includes a cable angle detector 20 that is provided on the front side of the housing 2 and that detects a cable angle θ of the cable 4 that is being paid out.

More specifically, the cable angle detector 20 of the present example embodiment is a mechanism that detects the angle of the cable 4 extending in the vertical direction, and includes a pair of support units 21, a rotation unit 22, a protruding unit 23, and an angle sensor 24.

Each of the pair of support units 21 includes one end fixed to the front side of the housing 2 and the other end extending to provide a horizontal rotating shaft for the rotation unit 22. The rotation unit 22 is formed with a through hole through which the cable 4 extending from the opening unit 3 of the housing 2 is inserted, and is rotatably connected to the pair of support units 21. The protruding unit 23 is an optional component of the cable angle detector 20, and is a structure for making it easier for rotational displacement of the rotation unit 22 to follow the extending direction of the cable 4. The angle sensor 24 can be, for example, a sensor similar to the rotary encoder 8 described above, and detects the rotation angle between the support units 21 and the rotation unit 22.

Thus, if the extension direction of the cable 4 that is being paid out from the opening unit 3 changes in response to movement of a user, the angle sensor 24 detects the rotation angle of the rotation unit 22 which rotates to follow the extension direction, and thus the cable angle detector 20 can detect the cable angle θ (−90°<θ<90°), for example. The cable angle θ is constantly transmitted from the angle sensor 24 to the controller 10 during the operation of the motion state display device 11.

Thus, the controller 10 can be configured or programmed to detect the cable angle θ in the vertical direction in addition to the stroke amount of the cable 4. Therefore, the controller 10 can more accurately recognize the state of movement of the user at each moment, and can control the braking force by the magneto-rheological fluid brake 9 to change the magnitude of the load according to the stroke amount and cable angle θ.

Note that the configuration of the cable angle detector 20 is merely an example, and other configurations having similar functions may be adopted. In addition, although the present example embodiment includes the cable angle detector 20 to detect the cable angle θ in the vertical direction, a similar component may be combined with the configuration to detect a cable angle φ in the horizontal direction, in addition to the cable angle θ. In this case, the motion state display device 11 can acquire the cable angle θ and the cable angle φ in addition to the stroke amount and thus identify the position of the end of the cable 4 in three-dimensional space. This allows for more precise control of the load according to the path of the movement. In addition, the motion state display device 11 can detect the actual measured speed along the swing path in three-dimensional space.

### Third Example Embodiment

Next, a third example embodiment of the present invention will be described. A motion state display system 12 according to the third example embodiment differs from the first example embodiment in that a plurality of motion state display devices 1 of the first example embodiment are cooperatively used. Hereinafter, only the portion that differs from that of the first example embodiment will be described, and the components common to the first and third example embodiments are denoted by the same reference signs and detailed description thereof will be omitted.

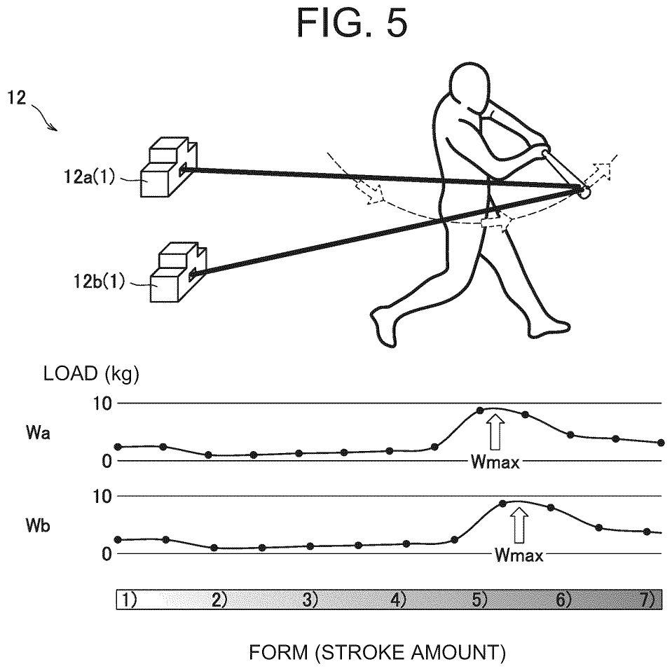

FIG. 5 is a conceptual diagram illustrating an example of use of the motion state display system 12 according to the third example embodiment. The motion state display system 12 includes a first motion state display device 12a and a second motion state display device 12b, each of which is the motion state display device 1 of the first example embodiment and which are spaced apart from each other. Further, in the present example embodiment, an end of the cable 4 of each of the first motion state display device 12a and the second motion state display device 12b is connected to or to the vicinity of the center of the bat B.

As indicated by dashed arrows, a force required for a batting movements change over time along a swing path of the bat B indicated by a dashed line. Thus, a load suitable for more practical movement should be changed in direction along a swing path.

In the motion state display system 12 of the present example embodiment, the load curves of the first motion state display device 12a and the second motion state display device 12b are set to have different waveforms, Wa and Wb, respectively, as shown in FIG. 5, and the first motion state display device 12a and the second motion state display device 12b cooperate to change the direction of the load. More specifically, Wa and Wb are set to provide a load which is a sum of a vector of load which the first motion state display device 12a applies to the cable 4 and a vector of load which the second motion state display device 12b applies to the cable 4, at each moment. The path of movement is calculated based on difference between the stroke amounts of the first motion state display device 12a and the second motion state display device 12b.

In the motion state display system 12 according to the third example embodiment, the first motion state display device 12a and the second motion state display device 12b cooperatively provide a load with a magnitude set according to the stroke amount of the cable 4 along the path of movement. Thus, the motion state display system 12 of the third example embodiment allows for display of motion state based on a load suitable for more practical movement.

The arrangement of the first motion state display device 12a and the second motion state display device 12b is appropriately set according to movement and the path of the movement. The end of the cable 4 of each of the first motion state display device 12a and the second motion state display device 12b may be connected to a different location on the bat B, to generate a complex load.

Although description of the example embodiments ends here, the present invention is not limited to the above-described example embodiments. The above-described example embodiments are example embodiments used for batting movements in baseball. However, for example, by appropriately setting an installation position and a load curve of the motion state display device, the present invention can be used for a different event or movement, including pitching in baseball, swings in tennis or golf, oar stroke motions in rowing, and attacks in volleyball. For example, in the case of oar stroke motions in rowing, the cable 4 is connected to a point on the oar along the extension of a line connecting a point gripped by a user and a fulcrum, to provide a resistive force against oaring motions. Furthermore, example embodiments of the present invention can be applied to a rehabilitation training device.

The above-described example embodiments are example embodiments in which the controller 10 is configured or programmed to transmit, to the display D, information such as speed of the cable 4 to cause the display D to display the information. However, such information may be transmitted for display to a mobile terminal, such as a smartphone or a tablet of the user, or a wearable terminal, such as a smartwatch, smartglasses, VR goggles, or AR goggles, for example.

The above-described example embodiments are example embodiments in which the reel 5 and the rotary encoder 8 are used as a measurer to measure the stroke amount of the cable 4. However, another method that can calculate the stroke amount of the cable 4 with respect to movement of a user may be used. For example, a master unit for wireless communication may be provided in the housing 2 of the motion state display device 1, a slave unit for wireless communication may be provided at the end of the cable 4, and the stroke amount of the cable 4 may be calculated based on changes in intensity of the radio wave or signal propagation time between the master unit and the slave unit, or the like.

In the housing 2 of the motion state display device 1, the rotation state of reel 5 may be detected using a camera, instead of the rotary encoder 8. In this case, for example, a disk with circularly evenly spaced markings may be provided on the rotating shaft 6 of the reel 5, and the stroke amount of the cable 4 may be detected based on intervals between reading times of the markings captured by the camera or a rotation speed.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motion state display device, comprising:
a cable that is paid out in response to movement of a user;
a measurer to measure a stroke amount of the cable;
a magneto-rheological fluid brake to apply a braking force to the cable;
a controller configured or programmed to control the braking force according to the stroke amount of the cable calculated based on an output value of the measurer, to change a load for the movement; and
a display operable to display a paying-out rate at which the cable is paid out.

2. A motion state display device, comprising:
a cable that is paid out in response to movement of a user;
a measurer to measure a stroke amount of the cable;
a magneto-rheological fluid brake to apply a braking force to the cable;
a controller configured or programmed to control the braking force according to the stroke amount of the cable calculated based on an output value of the measurer, to change a load for the movement; and
a display operable to display speed information of the cable.

3. A motion state display device, comprising:
a cable that is paid out in response to movement of a user;
a measurer to measure a stroke amount of the cable;
a magneto-rheological fluid brake to apply a braking force to the cable;
a controller configured or programmed to control the braking force according to the stroke amount of the cable calculated based on an output value of the measurer, to change a load for the movement; and
a display operable to display an actual measured waveform of a speed at which the cable is paid out.

4. The motion state display device according to claim 3, wherein the display is operable to display a targeted waveform of the speed.

5. The motion state display device according to claim 3, wherein the display is operable to display a waveform of the load according to the stroke amount.

6. A motion state display method, comprising:
measuring a stroke amount of a cable that is paid out in response to movement of a user;
applying, to the cable, a braking force according to the stroke amount, to change a load for the movement; and
displaying a paying-out rate at which the cable is paid out.

7. A motion state display method, comprising:
measuring a stroke amount of a cable that is paid out in response to movement of a user;
applying, to the cable, a braking force according to the stroke amount, to change a load for the movement; and
displaying speed information of the cable.

8. A motion state display method, comprising:
measuring a stroke amount of a cable that is paid out in response to movement of a user;
applying, to the cable, a braking force according to the stroke amount, to change a load for the movement; and
displaying an actual measured waveform of a speed at which the cable is paid out.

9. The motion state display method according to claim 8, wherein the displaying includes displaying a targeted waveform of the speed.

10. The motion state display method according to claim 8, wherein the displaying includes displaying a waveform of the load according to the stroke amount.
